(19) United States
(12) Patent Application Publication
(10) Pub. No.: US 2025/0302050 A1
(43) Pub. Date: Oct. 2, 2025

(54) PEST CONTROL COMPOSITIONS

(71) Applicants: Dow Global Technologies LLC, Midland, MI (US); Rohm and Haas Company, Collegeville, PA (US)

(72) Inventors: Caroline Woelfle-Gupta, Midland, MI (US); Selvanathan Arumugam, West Chester, PA (US); Susan L. Jordan, Doylestown, PA (US); Yujing Tan, Midland, MI (US)

(21) Appl. No.: 18/863,109

(22) PCT Filed: May 31, 2022
(86) PCT No.: PCT/US2022/031534

§ 371 Date: Nov. 5, 2024

(51) Int. Cl. A01N 63/23; A01N 65/00; A01P 15/00

(52) U.S. Cl. CPC A01N 63/23; A01N 65/00; A01P 15/00

(57) ABSTRACT

A pest control composition includes humic acid, a polymer having a weight average molecular weight from 10,000 daltons to 30,000 daltons and containing from 20 wt % to 100 wt % of monomeric structural units derived from a monomer with log P from 2.0 to 6.0. Bacillus thuringiensis and water.

### FIELD OF DISCLOSURE

The present disclosure is generally related to pest control compositions, and more specifically to pest control compositions comprising humic acid.

### BACKGROUND

Pest control agents are utilized to control pests, such as insects. The effectiveness of pest control agents can be influenced by a number of factors. There is continued focus in the industry on developing new and improved pest control compositions.

### SUMMARY

According to a first feature of the present disclosure, a pest control composition comprises humic acid, a polymer, wherein the polymer has a weight average molecular weight from 10,000 daltons to 30,000 daltons and contains from 20 wt % to 100 wt % of monomeric structural units derived from a monomer with log P from 2.0 to 6.0, Bacillus thuringiensis, and water. According to second feature of the present disclosure, the humic acid is from 0.010 wt % to 5.000 wt % of the composition based upon a total weight of a combination of the humic acid, the polymer, the Bacillus thuringiensis, and the water. According to third feature of the present disclosure, the polymer is from 0.10 wt % to 20.00 wt % of the composition based upon a total weight of the combination of the humic acid, the polymer, the Bacillus thuringiensis, and the water. According to fourth feature of the present disclosure, the polymer is a copolymer of diisobutylene and maleic anhydride. According to a fifth feature of the present disclosure, the humic acid has a phenolic group concentration of from 0.35 millimoles per gram of humic acid to 0.45 millimoles per gram of humic acid.

### DETAILED DESCRIPTION

As used herein, the term “and/or,” when used in a list of two or more items, means that any one of the listed items can be employed by itself, or any combination of two or more of the listed items can be employed. For example, if a composition is described as containing components A, B, and/or C, the composition can contain A alone; B alone; C alone; A and B in combination; A and C in combination; B and C in combination; or A, B, and C in combination.

All ranges include endpoints unless otherwise stated. Subscript values in polymer formulae refer to mole average values for the designated component in the polymer.

Test methods refer to the most recent test method as of the priority date of this document unless a date is indicated with the test method number as a hyphenated two-digit number. References to test methods contain both a reference to the testing society and the test method number. Test method organizations are referenced by one of the following abbreviations: ASTM refers to ASTM International (formerly known as American Society for Testing and Materials); EN refers to European Norm; DIN refers to Deutsches Institut für Normung; and ISO refers to International Organization for Standards.

As used herein, a “wt %” or “weight percent” or “percent by weight” of a component, unless specifically stated to the contrary, is based on the total weight of the composition or article in which the component is included. As used herein, all percentages are by weight unless indicated otherwise.

Pest control compositions are disclosed herein. Embodiments of the present disclosure provide that the pest control compositions include a polymer, humic acid, water and Bacillus thuringiensis.

The pest control compositions disclosed herein may be applied to plants, e.g., plant surfaces, to control pests. Advantageously, the pest control compositions disclosed herein can provide improved, i.e., greater, Bacillus thuringiensis activity following exposure to light, e.g., sunlight, as compared to other formulations. The Bacillus thuringiensis activity indicates that the pest control compositions disclosed herein can provide improved pest control, as compared to other formulations. Surprisingly, components of the pest control compositions disclosed herein, i.e., the humic acid, the polymer, and the Bacillus thuringiensis, show and unexpected synergy for improving Bacillus thuringiensis activity following exposure to light.

The pest control compositions disclosed herein include humic acid. Humic acid is an acidic organic polymer that can be extracted from humus found in soil, sediment, or aquatic environments. Humic acid is identified by the Chemical Abstracts Service (CAS) number 1415-93-6 and has an average chemical formula C₁₈₇H₁₈₆O₈₉N₉S₁. Humic acid may be obtained commercially. Examples of commercially available humic acid include, but are not limited to, products available from Sigma-Aldrich, or Fisher Scientific.

One or more embodiments of the present disclosure provide that the humic acid may be a solid, e.g., that is incorporated into the pest control compositions disclosed herein. One or more embodiments of the present disclosure provide that the humic acid may be a mixture, e.g., a mixture of humic acid and a liquid such as water, that is incorporated into the pest control compositions disclosed herein. One or more embodiments of the present disclosure provide that the humic acid may be a solution, e.g., a solution of humic acid in a liquid such as water that is incorporated into the pest control compositions disclosed herein. Combinations of solids, mixtures, and solutions may be utilized. The humic acid may have various pH values for various applications.

Humic acid comprises phenolic groups. The humic acid may have a phenolic group concentration of from 0.30 millimoles per gram of humic acid to 0.50 millimoles per gram of humic acid as determined according to the procedure laid out in the Examples section below. For example, the humic acid may have a phenolic group concentration in millimoles per gram of humic acid of 0.30 or greater, or 0.31 or greater, or 0.32 or greater, or 0.33 or greater, or 0.34 or greater, or 0.35 or greater, or 0.36 or greater, or 0.37 or greater, or 0.375 or greater, or 0.38 or greater, or 0.39 or greater, or 0.40 or greater, or 0.41 or greater, or 0.42 or greater, or 0.43 or greater, or 0.44 or greater, or 0.45 or greater, or 0.46 or greater, or 0.47 or greater, or 0.48 or greater, or 0.49 or greater, while at the same time, 0.50 or less, or 0.49 or less, or 0.48 or less, or 0.47 or less, or 0.46 or less, or 0.45 or less, or 0.44 or less, or 0.43 or less, or 0.42 or less, or 0.41 or less, or 0.40 or less, or 0.39 or less, or 0.38 or less, or 0.375 or less, or 0.37 or less, or 0.36 or less, or 0.35 or less, or 0.34 or less, or 0.33 or less, or 0.32 or less, or 0.31 or less.

The pest control compositions disclosed herein can include a polymer. As used herein, “a” refers to one or more unless indicated otherwise. As used herein a “polymer” has two or more of the same or different monomeric structural units derived from two or more different monomers, e.g., copolymers, terpolymers, etc. “Monomeric structural unit”, as used herein in reference to polymers, indicates a portion of the polymer structure that results from a reaction of a monomer or monomers to form the polymer. “Different” in reference to monomeric structural units indicates that the monomeric structural units differ from each other by at least one atom or are different isomerically. Embodiments of the present disclosure provide that the monomeric structural units of the polymer result, i.e. are formed, from a polymerization reaction of the monomers. One or more embodiments provide that a monomeric structural unit may undergo one or more reactions subsequent to the polymerization reaction, e.g., a hydrolysis reaction.

Embodiments of the present disclosure provide that the polymer contains from 20 wt % to 100 wt % of monomeric structural units derived from a monomer, i.e. one or more monomers, with log P of from 2.0 to 6.0, based upon a total weight of the polymer. The polymer may contain greater than 90 wt % of monomeric structural units derived from a monomer with log P of greater than 1.0.

One or more of the monomeric structural units may have a log P of 1.0 or greater, or 1.2 or greater, or 1.4 or greater, or 1.6 or greater, or 1.8 or greater, or 2.0 or greater, or 2.2 or greater, or 2.4 or greater, or 2.6 or greater, or 2.8 or greater, or 3.0 or greater, or 3.2 or greater, or 3.4 or greater, or 3.6 or greater, or 3.8 or greater, or 4.0 or greater, or 4.2 or greater, or 4.4 or greater, or 4.6 or greater, or 4.8 or greater, while at the same time, 5.0 or less, or 4.8 or less, or 4.6 or less, or 4.4 or less, or 4.2 or less, or 4.0 or less, or 3.8 or less, or 3.6 or less, or 3.4 or less, or 3.2 or less, or 3.0 or less, or 2.8 or less, or 2.6 or less, or 2.4 or less, or 2.2 or less, or 2.0 or less, or 1.8 or less, or 1.6 or less, or 1.4 or less, or 1.2 or less. Log P values are determined by utilizing the Estimation Programs Interface (EPI) Suite™, (KOWWIN version 1.68) available at https://www.epa.gov/tsca-screening-tools/epi-suitetm-estimation-program-interface.

Exemplary monomers with log P for use in the polymer include diisobutylene (log P of 4.08), butyl methacrylate (log P of 2.75), butyl acrylate (log P of 2.20), methyl methacrylate (log P of 1.28), ethyl acrylate (log P of 1.22), 2-ethylehexyl acrylate (log P of 4.09), styrene (log P of 2.89), maleic anhydride (log P of 1.62), docosyl methacrylate (log P of 11.59), and combinations thereof.

As mentioned, the polymer may contain from 20 wt % to 100 wt % of monomeric structural units derived from a monomer with log P from 2.0 to 6.0. For example, the polymer may comprise 20 wt % or greater, or 25 wt % or greater, or 30 wt % or greater, or 35 wt % or greater, or 40 wt % or greater, or 45 wt % or greater, or 50 wt % or greater, or 55 wt % or greater, or 60 wt % or greater, or 65 wt % or greater, or 70 wt % or greater, or 75 wt % or greater, or 80 wt % or greater, or 85 wt % or greater, or 90 wt % or greater, or 95 wt % or greater, while at the same time, 100 wt % or less, or 95 wt % or less, or 90 wt % or less, or 85 wt % or less, or 80 wt % or less, or 75 wt % or less, or 70 wt % or less, or 65 wt % or less, or 60 wt % or less, or 55 wt % or less, or 50 wt % or less, or 45 wt % or less, or 40 wt % or less, or 35 wt % or less, or 30 wt % or less, or 25 wt % or less of monomeric structural units derived from a monomer with log P from 2.0 to 6.0.

The polymer may contain 90 wt % of monomeric structural units derived from a monomer with log P of greater than or equal to 1.0. For example, the polymer may contain 91 wt % or greater, or 92 wt % or greater, or 93 wt % or greater, or 94 wt % or greater, or 95 wt % or greater, or 96 wt % or greater, or 97 wt % or greater, or 98 wt % or greater, or 99 wt % or greater, while at the same time, 100 wt % or less, or 99 wt % or less, or 98 wt % or less, or 97 wt % or less, or 96 wt % or less, or 95 wt % or less, or 94 wt % or less, or 93 wt % or less, or 92 wt % or less, or 91 wt % or less of a monomer with log P of 1.0 or greater.

The polymer may comprise structural units from one or more of itaconic acid, fumaric acid, crotonic acid, acrylic acid, methacrylic acid, maleic acid, acryloxypropionic acid, citraconic acid, methyl acrylate, vinyl acetate, and combinations thereof.

Embodiments of the present disclosure provide that the polymer has a weight average molecular weight from 10,000 daltons to 30,000 daltons. For example, the polymer may have a weight average molecular weight of 10,000 daltons or greater, or 11,000 daltons or greater, or 12,000 daltons or greater, or 13,000 daltons or greater, or 14,000 daltons or greater, or 15,000 daltons or greater, or 16,000 daltons or greater, or 17,000 daltons or greater, or 18,000 daltons or greater, or 19,000 daltons or greater, or 20,000 daltons or greater, or 21,000 daltons or greater, or 22,000 daltons or greater, or 23,000 daltons or greater, or 24,000 daltons or greater, or 25,000 daltons or greater, or 26,000 daltons or greater, or 27,000 daltons or greater, or 28,000 daltons or greater, or 29,000 daltons or greater, while at the same time, 30,000 daltons or less, or 29,000 daltons or less, or 28,000 daltons or less, or 27,000 daltons or less, or 26,000 daltons or less, or 25,000 daltons or less, or 24,000 daltons or less, or 23,000 daltons or less, or 22,000 daltons or less, or 21,000 daltons or less, or 20,000 daltons or less, or 19,000 daltons or less, or 18,000 daltons or less, or 17,000 daltons or less, or 16,000 daltons, or less, or 15,000 daltons or less, or 14,000 daltons or less, or 13,000 daltons or less, or 12,000 daltons or less, or 11,000 daltons or less. The weight average molecular weight of the polymer is determined using gel permeation chromatography.

The polymer can be prepared using known equipment, reaction components, and reaction conditions. For instance, the polymer can be prepared by known polymerization, e.g., solution polymerization. The solution polymerization of monomers, i.e., monomers discussed herein, can be performed in a non-aqueous solvent, for instance. Suitable solvents include, but are not limited to, toluene, xylenes, propylene glycol, methylethylketone, and combinations thereof. The solution polymerization can include a solvent-soluble initiator. Examples of the initiator include, but are not limited to, t-butylperoctoate, t-butylhydroperoxide, AIBN, 2,2-azobis(2,4-dimethyl-pentanenitrile), t-butylperoxybenzoate, and combinations thereof. The initiator may be used from 0.01 wt % to 1.00 wt %, based on a total weight of monomers utilized in the solution polymerization, for instance. The solution polymerization may utilize a chain transfer agent. Examples of the chain transfer agent include, but are not limited to, 2-mercaptoethanol, 3-methylmercaptopropionic acid, n-dodecylmercaptan, t-dodecylmercaptan, and combinations thereof. The chain transfer agent may be used from 0.01 wt % to 5.00 wt %, based on a total weight of monomers utilized in the solution polymerization, for instance. The use of a mercaptan modifier may reduce the molecular weight of the polymer. Other known components may be utilized for the solution polymerization; different amount of these other known components may be utilized for various applications.

The polymer can be prepared by known polymerization, e.g., emulsion polymerization. The emulsion polymerization may utilize a surfactant. Examples of surfactants include, but are not limited to, anionic surfactants such as sodium laurylsulfate, sodium dodecylbenzenesulfonate, and sodium ethoxylated [C₁₀] alcohol half-ester of sulfosuccinic acid, and combinations thereof. The surfactant may be used from 0.5 wt % to 6.0 wt %, based on a total weight of monomers utilized in the emulsion polymerization, for instance. The emulsion polymerization may utilize an initiator, such as a water-soluble initiator, for instance. Examples of initiators include, but are not limited to, alkali metal persulfates, ammonium persulfate, and combinations thereof. The initiator may be utilized from 0.01 wt % to 1.00 wt %, based on a total weight of monomers utilized in the emulsion polymerization. The emulsion polymerization may utilize a chain transfer mercaptan. Examples of chain transfer mercaptans include, but are not limited to, 2-mercaptopropionic acid, 3-methylmercaptopropionic acid, alkyl mercaptans containing from 4 to 20 carbon atoms, and combinations thereof. The chain transfer mercaptan may be utilized from 0.01 wt % to 5.00 wt % based on a total weight of monomers utilized in the emulsion polymerization. The use of mercaptan modifier may reduce the molecular weight of the polymer. Other known components may be utilized for the emulsion polymerization; different amount of these other known components may be utilized for various applications.

The polymer may be obtained commercially under various tradenames.

As mentioned, a monomeric structural unit of the polymer described herein may undergo one or more reactions subsequent to the polymerization reaction, e.g., a hydrolysis reaction. The hydrolysis reaction can include the hydrolysis of an ester to an acid or the ring-opening of an anhydride to an acid, for example.

The pest control compositions disclosed herein comprise Bacillus thuringiensis. As defined herein, “Bacillus thuringiensis” is the spores and/or the crystallized proteins of the species Bacillus thuringiensis and includes all Bacillus thuringiensis subspecies exhibiting insecticidal properties. Examples of such subspecies include kurstaki, israelensis and aizawa. The Bacillus thuringiensis may be added to the pest control composition as either a solid or as part of a liquid formulation. The presence and subspecies of Bacillus thuringiensis is determined by Random Amplified Polymorphic DNA analysis. A commercially available liquid formulation of Bacillus thuringiensis is THURICIDE™ pesticide available from Certis USA, Columbia, Maryland.

The pest control compositions disclosed herein can include water. One or more embodiments of the present disclosure provide that the pest control composition is a solution, i.e., the polymer and the Bacillus thuringiensis is water soluble. Advantageously, the pest control compositions disclosed herein may overcome a number of issues, e.g., utilize fewer components, such as surfactants, that are utilized with emulsions and/or dispersions, and/or redispersible polymers. Different amounts of water may be utilized for various applications.

One or more embodiments of the present disclosure provide that the pest control compositions disclosed herein can include an additive. Examples of additives include viscosity modifiers, pH modifiers, herbicides, fungicides, and combinations thereof, among others. Different amount of the additive may be utilized for various applications.

The pest control compositions disclosed herein can include from 0.010 wt % to 5.000 wt % of the humic acid, based upon a total weight of a combination of the humic acid, the polymer, the Bacillus thuringiensis, and the water. All individual values and subranges from 0.010 wt % to 5.000 wt % are included; for example, the pest control composition can include the humic acid from a lower limit of 0.010 wt %, 0.050 wt %, 0.100 wt %, or 0.150 wt % to an upper limit of 5.000 wt %, 4.000 wt %, 3.500 wt %, or 3.000 wt % based upon the total weight of the combination of the humic acid, the polymer, the Bacillus thuringiensis, and the water.

The pest control compositions disclosed herein can include from 0.10 wt % to 20.00 wt % of the polymer, based upon a total weight of a combination of the humic acid, the polymer, the Bacillus thuringiensis, and the water. All individual values and subranges from 0.10 wt % to 20.00 wt % are included; for example, the pest control composition can include the polymer from a lower limit of 0.10 wt %, 0.15 wt %, 0.20 wt %, 0.25 wt %, or 0.30 wt % to an upper limit of 20.00 wt %, 15.00 wt %, 10.00 wt %, 9.00 wt %, or 8.00 wt % based upon the total weight of the combination of the humic acid, the polymer, the Bacillus thuringiensis, and the water.

The pest control compositions disclosed herein can include from 0.01 wt % to 20.00 wt % of the Bacillus thuringiensis, based upon a total weight of a combination of the humic acid, the polymer, the Bacillus thuringiensis, and the water. All individual values and subranges from 0.01 wt % to 20.00 wt % are included; for example, the pest control composition can include the Bacillus thuringiensis from a lower limit of 0.01 wt %, 0.02 wt %, 0.03 wt %, 0.04 wt %, or 0.05 wt % to an upper limit of 20.00 wt %, 15.00 wt %, 10.00 wt %, 7.50 wt %, 5.00 wt %, 4.75 wt %, or 4.50 wt % based upon the total weight of the combination of the humic acid, polymer, the Bacillus thuringiensis, and the water.

The pest control compositions disclosed herein can include from 55.00 wt % to 99.79 wt % of water, based upon a total weight of a combination of the humic acid, the polymer, the Bacillus thuringiensis, and the water. All individual values and subranges from 55.00 wt % to 99.79 wt % are included; for example, the pest control composition can include the water from a lower limit of 55.00 wt %, 60.00 wt %, 70.00 wt %, or 80.00 wt % to an upper limit of 99.79 wt %, 99.00 wt %, 98.00 wt %, or 95.00 wt % based upon the total weight of the combination of the humic acid, the polymer, the Bacillus thuringiensis, and the water.

The pest control compositions disclosed herein can be formed using known equipment and processes. The components of the pest control compositions may be combined, e.g., mixed, to form the pest control compositions. For instance, the components of the pest control compositions may be added to a vessel and be agitated therein. The components of the pest control compositions may be combined in any order.

The pest control compositions disclosed herein may be applied to plants, e.g., plant surfaces, to control pests. The pest control compositions may be applied to plants using known equipment and processes. For instance, the pest control compositions may be sprayed, sprinkled, and/or poured, among other applications, to plants. Different amounts of the pest control composition may be applied to plants for various applications.

### Examples

In the Examples, various terms and designations for materials are used including, for instance, the following:

THURICIDE™ (liquid formulation, Bacillus thuringiensis, manufactured by Certis); humic acid-1 (humic acid, solid, pH 9.3, as determined with 2.5 wt % humic acid-1 solution having a phenolic group concentration of 0.375 millimoles per gram of humic acid, obtained under the tradename ACTIVEHUME™ from ORGANOCAT, Louisville, Kentucky); humic acid-2 (solid humic acid obtained from SIGMA-ALDRICH); polyethylene oxide functionalized lignin. The phenolic group concentration of humic acid-1 was determined by making a humic acid solution (0.1 wt % humic acid and water). An aliquot of the humic acid solution was combined with an assay solution; the assay solution contained 4 wt % cupric sulfate solution (excess of Cu²⁺ salt; 7758-99-8; Purchased from Thermo Fisher; Product #23224), and bicinchoninic acid (CAS 1245-13-2; obtained from Millipore Sigma; Product #B9643). Phenolic groups reduced the Cu²⁺ to Cu+ and formed a purple colored complex with the bicinchoninic acid; the concentration of formed complex was determined colorimetrically by measuring absorbance at 562 nm Varian Cary™ 50 UV-Vis spectrophotometer. From the concentration of the Cu+-BCA, the concentration of phenolic groups in humic acid-1 was determined using hydroquinone as the calibration standard; the linear calibration curve with hydroquinone plotted absorbance on the y-axis vs. nanomoles of phenolic groups on the x-axis, where y=0.0104x and R-squared=0.9989. The phenolic group concentration was determined as nanomoles of phenol in the aliquot and the dilution factor and humic acid mass was used to convert the nanomoles to millimoles/g of humic acid.

Polymer-1 was formed as follows. A solution polymerization was utilized to form a copolymer derived from diisobutylene and maleic anhydride. The wt % of polymer-1 formed from monomeric structural units to diisobutylene is from 45 wt % to 55 wt % with the remainder being maleic anhydride. The polymer was hydrolyzed with aqueous ammonia to provide Polymer-1. Polymer-1 had a weight average molecular weight of approximately 16,500 daltons.

Example 1, a pest control composition, was formed as follows. Polymer-1 was diluted with deionized water to provide a solution (5 wt % of Polymer-1 in water). The solution (1 mL), THURICIDE™ (7.38 wt % in water; 9.38 mL), and humic acid-1 (2.5 wt % in water; 0.26 mL) were added to a container and mixed with a magnetic stir bar to provide Example 1. The phenolic group concentration of the humic acid in Example 1 was 0.423077 millimoles/g of humic acid.

Example 2, a pest control composition, was formed as Example 1 with the change that humic acid-2 (0.26 mL) was utilized rather than the humic acid-1. The phenolic group concentration of the humic acid in Example 2 was 0.3942 millimoles/g of humic acid.

Comparative Example A was formed as Example 1 with the change that Polymer-1 was not utilized.

Comparative Example B was formed as Example 1 with the changes that that humic acid-2 (0.26 mL) was utilized rather than the humic acid-1 and Polymer-1 was not utilized.

Comparative Example C was formed as Example 1 with the change that the polyethylene oxide functionalized lignin was utilized rather than the humic acid-1 and Polymer-1 was not utilized.

Comparative Example D was formed as Example 1 with the change that the polyethylene oxide functionalized lignin was utilized rather than the humic acid-1.

Bacillus thuringiensis activities before and after exposure to light for Examples 1-2 and Comparative Examples A-D were determined as follows.

An auto-pipettor was used to place respective 30 μL drops of Examples 1-2 and Comparative Examples A-D on a plastic petri dish; the drops were dried for approximately 1 hour.

For the samples exposed to light, the dried drops were exposed to light at 35 milliwatts/cm² for 2 hours.

The samples not exposed to light and the samples exposed to light were extracted and plated. For extraction, each of the samples was placed in 1 wt % solution of TWEEN® 20 solution and incubated for approximately 12 hours. For plating, the samples were diluted to a desired starting concentration, using a 0.1 wt % solution of TWEEN® 20 then serially diluted at suitable concentrations and plated evenly in 10 μL drops. The plates were then held in an incubator at 30° C. for approximately 12 hours. Thereafter, the number of colonies were counted and expressed as log colony forming units/mL, while accounting for dilution factors. The results are reported in Tables 1-3.

TABLE 1

| | Bacillus | | |
|---|---|---|---|
| | thuringiensis | Bacillus | Relative |
| | activity | thuringiensis | Bacillus |
| | before light | activity | thuringiensis |
| | exposure | after light exposure | activity after |
| | (log CFU/mL) | (log CFU/mL) | light exposure |
| Example 1 | 8.88 ± 0.05 | 7.16 ± 0.11 | 3.5 times |
| | | | greater |
| Comparative | 8.92 ± 0.04 | 6.61 ± 0.03 | 1.0 |
| Example A | | | |

The data of Table 1 illustrates that Example 1 has an improved, i.e. 3.5 times greater, pest control agent activity after light exposure as compared to Comparative Example A.

TABLE 2

| | Bacillus | | |
|---|---|---|---|
| | thuringiensis | Bacillus | Relative |
| | activity | thuringiensis | Bacillus |
| | before light | activity | thuringiensis |
| | exposure | after light exposure | activity after |
| | (log CFU/mL) | (log CFU/mL) | light exposure |
| Example 2 | 8.93 ± 0.11 | 7.10 ± 0.15 | 5.2 times |
| | | | greater |
| Comparative | 8.94 ± 0.05 | 6.38 ± 0.04 | 1.0 |
| Example B | | | |

The data of Table 2 illustrates that Example 2 has an improved, i.e. 5.2 times greater, pest control agent activity after light exposure as compared to Comparative Example B.

TABLE 3

| | Bacillus | | |
|---|---|---|---|
| | thuringiensis | Bacillus | Relative |
| | activity | thuringiensis | Bacillus |
| | before light | activity | thuringiensis |
| | exposure | after light exposure | activity after |
| | (log CFU/mL) | (log CFU/mL) | light exposure |
| Comparative | 8.98 ± 0.04 | 6.98 ± 0.12 | 1.0 |
| Example C | | | |
| Comparative | 8.96 + 0.07 | 6.00 + 0.14 | 10 times less |
| Example D | | | |

The data of Table 3 illustrates that Comparative Example D has a decreased, i. e. 10 times less, pest control agent activity after light exposure as compared to Comparative Example C. This decreased pest control agent activity after light exposure further illustrates the surprising synergy of the components of the pest control compositions disclosed herein.

1. A pest control composition comprising:
humic acid;
a polymer, wherein the polymer has a weight average molecular weight from 10,000 daltons to 30,000 daltons and contains from 20 wt % to 100 wt % of monomeric structural units derived from a monomer with log P from 2.0 to 6.0;
Bacillus thuringiensis; and
water.

2. The pest control composition of claim 1, wherein: the humic acid is from 0.010 to 5.000 wt % of the composition based upon a total weight of a combination of the humic acid, the polymer, the Bacillus thuringiensis, and the water.

3. The pest control composition of any one of claim 1, the polymer is from 0.10 to 20.00 wt % of the composition based upon a total weight of the combination of the humic acid, the polymer, the Bacillus thuringiensis, and the water.

4. The pest control composition of any one of claim 1, wherein the polymer is a copolymer of diisobutylene and maleic anhydride.

5. The pest control composition of any one of claim 1, wherein the humic acid has a phenolic group concentration of from 0.35 millimoles per gram of humic acid to
0.45 millimoles per gram of humic acid.
